(19) United States
(12) Patent Application Publication
(10) Pub. No.: US 2020/0237623 A1
(43) Pub. Date: Jul. 30, 2020

(54) Powdered Infant Formula Measuring And Mixing Pod And Baby Bottle Assembly

(71) Applicants: Yuraisi De La Rosa, Miami Springs, FL (US); Charles De La Rosa, Miami Springs, FL (US)

(72) Inventors: Yuraisi De La Rosa, Miami Springs, FL (US); Charles De La Rosa, Miami Springs, FL (US)

(21) Appl. No.: 16/258,553

(22) Filed: Jan. 26, 2019

(51) Int. Cl. A61J 9/00

(52) U.S. Cl. CPC A61J 9/008; A47J 43/27; A61J 9/001

(57) ABSTRACT

An apparatus for use with baby bottles, a baby bottle assembly, and a method of preparing liquid infant formula for feeding to a baby are disclosed. A measuring and mixing pod allows the appropriate amount of powdered infant formula to be measured out in advance and stored within the baby bottle from which it is to be served. The same bottle may be filled with water or other liquid while keeping the powdered formula dry. Further, a simple and quick method is provided for mixing the powdered formula with the liquid stored in the bottle when it is time to feed the baby.

### FIELD OF THE INVENTION

The present invention relates to a measuring and mixing pod for use with a baby bottle, a baby bottle assembly, and a method of producing a serving of infant formula.

### BACKGROUND

Caring for an infant can be a hectic and chaotic endeavor. Babies, it seems, require near constant attention. Sleepless nights, diaper changes and feedings become the all consuming events in new parents' lives. The chaos of caring for an infant multiplies when the parents attempt to leave the home with their baby in order to carry on at least a semblance of their former lives.

Keeping the child fed is one of the great challenges of going abroad with an infant in tow. Bottles of infant formula prepared in advance can spoil if not refrigerated. Mixing formula on the go is difficult and inconvenient. Consider, for example, all of the components that must be remembered and brought along by the parent in order to prepare a serving of liquid infant formula away from home: the bottle assembly—including the bottle itself, a nipple, and the circular ring for securing the nipple to the bottle; a container of powdered infant formula; and a measuring scoop for measuring out the proper amount of powdered infant formula from the container. All of these components must be located and assembled when it is time to feed the baby. A source of fresh water must also be found to fill the bottle. The appropriate amount of powdered formula must be measured out and mixed with the water. All of this must take place while the baby is making its nutritional demands known in the only way it knows how.

A simpler solution for transporting and preparing infant formula is most certainly in order. Ideally, an improved solution for preparing bottles of infant formula will allow the ingredients to be measured out in advanced, and stored in a manner that prevents the infant formula from going bad over an extended period of time. Such a solution should allow the ingredients to be easily transported and quickly and easily mixed together to produce a serving of liquid infant formula on an on-demand basis. The present invention provides such a solution.

### SUMMARY OF THE INVENTION

The present invention relates to an apparatus for use with baby bottles, a baby bottle assembly, and a method of preparing liquid infant formula for feeding a baby. The invention allows the appropriate amount of powdered infant formula to be measured out in advance and stored within the bottle from which it will be served. The invention further allows the same bottle to be filled with water or other liquid while keeping the powdered formula dry. The invention further provides a simple and quick method of mixing the powdered formula with the liquid stored in the bottle when it is time to feed the baby.

An embodiment of the invention provides a measuring and mixing pod for storing powdered infant formula within a baby bottle assembly and for selectively mixing the powdered infant formula with the liquid contents of the baby bottle to prepare a serving of liquid infant formula. The baby bottle assembly includes a bottle having a threaded neck portion. The bottle is adapted to hold a specific volume of liquid corresponding to a single serving of infant formula. The assembly further includes a flexible and resilient nipple and a threaded fastening ring which is adapted to secure the nipple over the bottle. The measuring and mixing pod includes a generally cylindrically shaped wall. A base portion encloses a lower end of the generally cylindrical wall. A post extend upward from the base and extends axially within cylindrical wall. The post has a height greater than a height of the cylindrical wall so that the post extends beyond the height of the pod. The axial wall, the base, and post define a generally toroidal cavity within the measuring and mixing pod. The cavity has a volume equal to the volume of powdered infant formula required to make a serving of liquid infant formula corresponding to the volume of liquid the bottle is adapted to hold.

Another embodiment of the invention provides a baby bottle assembly. The baby bottle assembly includes a baby bottle having threaded neck portion. The neck portion defines an annular rim that defines the mouth of the bottle. The baby bottle is sized to hold an amount of liquid corresponding a serving of liquid infant formula. The baby bottle assembly further includes a flexible and resilient nipple. The nipple has a nursing portion which a baby can suck on to draw liquid formula from the bottle, and a base portion which is adapted to extend over the mouth of the bottle. The base portion defines an annular gasket and has an inner surface that defines an inner surface diameter. A threaded fastening ring is provided to secure the nipple over the mouth of the bottle. The fastening ring includes an internal annular flange configured to compress the gasket defined by the base portion of the nipple against the rim of the bottle when the fastening ring is screwed onto the neck of the bottle. The baby bottle assembly further includes a measuring and mixing pod. The measuring and mixing pod includes a pod base, a cylindrical wall and a post that extends axially within cylindrical wall from the pod base. The pod base, the cylindrical wall and the post define a cavity within the measuring and mixing pod. The cavity has a volume substantially equal to the volume of powdered infant formula required to produce a serving of liquid infant formula corresponding to the size of the bottle. The cylindrical wall has an outer diameter that corresponds to the inner surface diameter of the inner surface of the base portion of the nipple. This allows the measuring and mixing pod to be press fit into the base portion of the nipple and frictionally retained therein.

Finally, a method of preparing a serving of liquid infant formula is provided. The method calls for providing a bottle having a threaded neck that includes an annular rim that defines the mouth of the bottle. The bottle is to hold an amount of liquid corresponding to one serving of liquid infant formula. The method further calls for providing a flexible and resilient nipple. The nipple is to have a nursing portion and a base portion. The base portion is to define an annular gasket and is to have an inner surface that defines an inner surface diameter. The method further calls for providing a threaded fastening ring adapted to be rotatably mounted to the neck of the bottle in order to secure the nipple over the mouth of the bottle. The fastening ring is to include an internal annular flange that compresses the gasket defined by the base portion of the nipple against the rim of the bottle when the fastening ring is screwed on tightly to the neck of the bottle. The method of preparing a serving of liquid infant formula further calls for providing a measuring and mixing pod. The measuring and mixing pod is to have a pod base, a cylindrical wall, and a post that extends axially within the cylindrical wall from the base of the pod. A cavity is defined by pod base, the cylindrical wall and the post. The cavity is to have a volume substantially equal to the volume of powdered infant formula required to produce a serving of liquid infant formula equal to the serving size that the bottle is adapted to hold. The cylindrical wall of the mixing and measuring pod is to have a first outer diameter that corresponds to the inner surface diameter of the inner surface of the base portion of the nipple. With this arrangement the pod may be press fit into the base portion of the nipple and frictionally retained therein. Once the bottle assembly has been provided, the method of preparing a serving of liquid infant formula further calls for filling the bottle with liquid in an amount corresponding to a serving of liquid infant formula and filling the cavity defined by the pod base, the cylindrical wall and the post with powdered infant formula. The measuring and mixing pod filled with powdered infant formula is then press-fit into the base portion of the nipple. The nipple along with the measuring and mixing pod frictionally retained therein are then secured over the mouth of the bottle with the fastening ring. When it is time to feed the baby, the method calls for releasing the measuring and mixing pod from the base of the nipple. Once the measuring and mixing pod is released from the base of the nipple, it falls into the liquid contents of the bottle, releasing the powdered formula stored within the cavity into the liquid. The bottle is then shaken to mix the powdered infant formula with the liquid. While the bottle is being shaken, the measuring and mixing pod bounces around in the bottom of the bottle, acting as an agitator to help thoroughly and evenly mix the powdered infant formula throughout the liquid contents of the bottle.

### BRIEF DESCRIPTION OF THE DRAWINGS

FIG. 1 is a perspective view of a measuring and mixing pod according to an embodiment of the invention;

FIG. 2 is a cross-sectional view of the measuring and mixing pod shown in FIG. 1;

FIG. 3 is a cross-sectional view of the measuring and mixing pod shown in FIG. 1 filled with powdered infant formula;

FIG. 4 is an exploded perspective view of a baby bottle assembly including a measuring and mixing pod according to an embodiment of the invention;

FIG. 5 is a cross-sectional view of a fully assembled baby bottle assembly according to an embodiment of the invention that has been prepared for use;

FIG. 6 is a cross-sectional view of the baby bottle assembly shown in FIG. 5 in which a caregiver has begun the process of mixing a serving of liquid infant formula; and

FIG. 7 is a cross-sectional view of the baby bottle assembly shown in FIG. 5 during the final stage of preparing a serving of liquid infant formula.

### DETAILED DESCRIPTION

The present invention relates to a measuring and mixing pod for use with a typical baby bottle assembly. The measuring and mixing pod aids in measuring, transporting and mixing powdered infant formula with the liquid contents of a baby bottle to generate a serving of liquid infant formula for feeding a baby. The invention further relates to a baby bottle assembly including such a measuring and mixing pod, as well as a method for measuring, transporting and mixing infant formula within a baby bottle assembly including a measuring and mixing pod as disclosed herein.

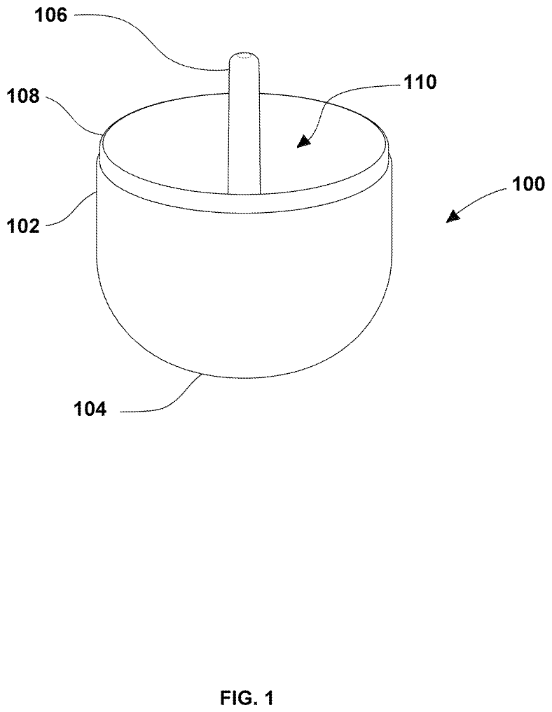

Turning first to FIGS. 1, 2, and 3, an infant formula measuring and mixing pod 100 according to an embodiment of the present invention defines a unitary component made of molded plastic or some similar material. The pod 100 includes a generally cylindrical wall 102 and a curved base 104. The base 104 may include a flattened portion 114 that allows the pod 100 to stand upright when placed on a flat surface, so as not to tip and spill the contents of the pod 100 during the preparation of a bottle of infant formula. The cylindrical wall 102 may include a notched portion 108 near the top of the wall. The notched portion 108 presents a slightly smaller outer diameter than to rest of the cylindrical wall 102. As will be described in more detail below, the two different diameters allow the pod 100 to be used with baby bottle assemblies made by different manufacturers, or simply baby bottle assemblies of two different sizes having different internal dimensions.

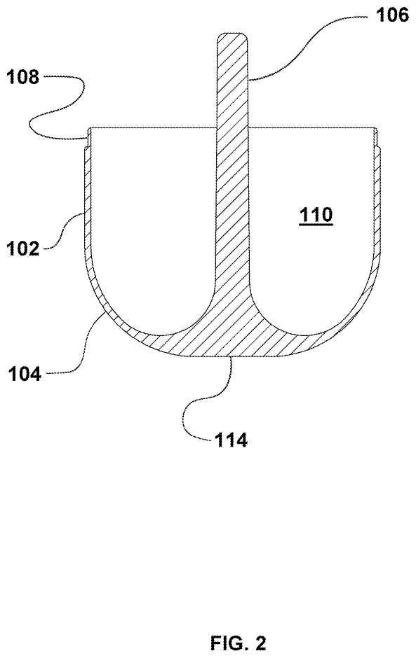

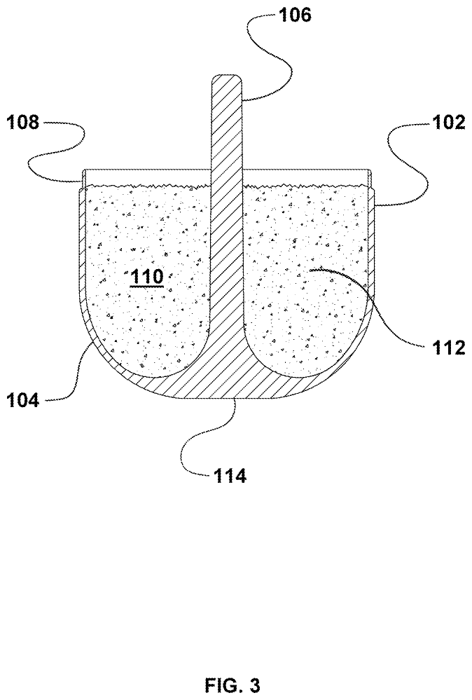

As seen in the cross-sectional views of FIGS. 2 and 3, a push rod or post 106 rises from the base 104 of the pod 100 and extends upward above the height of the cylindrical wall 102. The cylindrical wall 102, the base 104 and the post 106 define a toroidal space or cavity 110 within the pod 100. The upper portion of the pod 100 is open so that powdered infant formula 112 may be scooped into or otherwise introduced into the cavity 110. The dimensions of the pod 100 are such that volume of the cavity 110 is substantially equal to the volume of powdered infant formula required to make a single serving of liquid formula corresponding to the size of the bottle with which the pod 100 paired. For example, the pod 100 may be intended for use with a 4 ounce baby bottle. In such case, the cavity 110 formed within the pod 100 may be sized to hold an amount of powdered infant formula necessary to make 4 ounces of liquid infant formula. Alternatively, a pod may be intended for use in an 8 ounce bottle. In this case, the cavity 110 formed within the pod 100 may be sized to hold an amount of powdered infant formula corresponding to an 8 ounce serving of liquid infant formula. Of course, the measuring and mixing pod could also be configured to work with baby bottle assemblies intended to hold other than 4 and 8 ounce serving sizes.

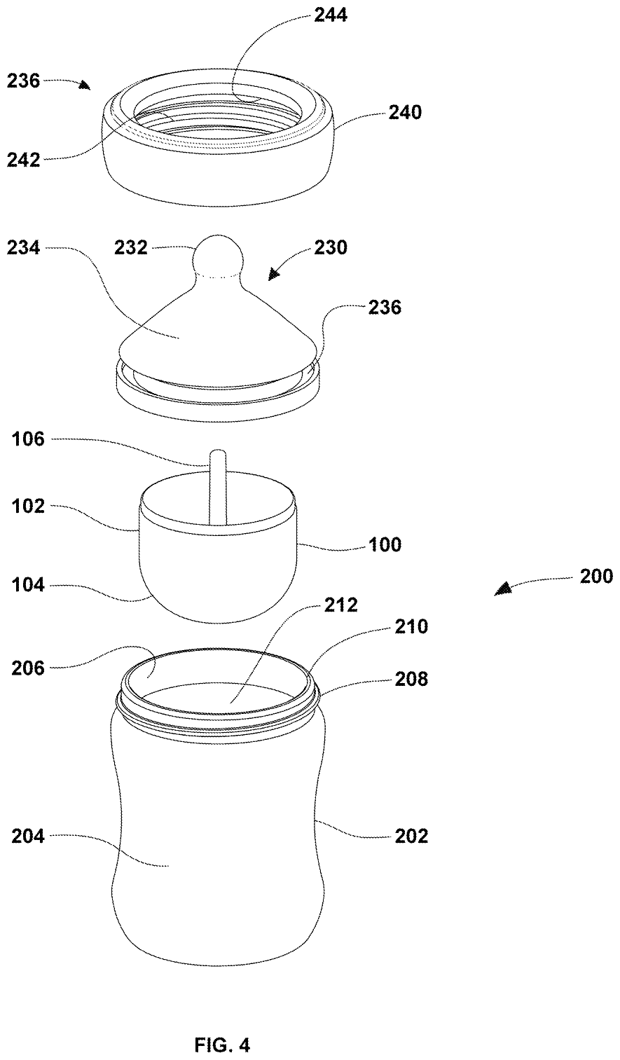

FIG. 4 shows an exploded perspective view of a baby bottle assembly 200 incorporating a measuring and mixing pod 100 according to an embodiment of the invention. The baby bottle assembly 200 include a bottle 202, a measuring and mixing pod 100 as described above, a nipple 230, and a fastening ring 240. The bottle 202 defines an internal space 204 for holding liquid such as water, milk, or infant formula. The bottle includes a neck portion 206 that includes external threads 208. The neck 206 terminates in an annular rim 210 that defines the mouth 212 of the bottle 202. The nipple 230 is formed of a flexible and resilient elastomeric material such as silicone rubber and includes an upper nursing portion 232 and a base portion 234. The base portion 234 includes an annular gasket portion 236. The fastening ring 240 includes internal threads 242 and an internal annular flange 244. The Nipple 230 is adapted to be inserted through the fastening ring 240 so that the annular gasket 236 at the base portion 234 of the nipple 230 engages the lower surface of the inner flange 244 of the fastening ring 230.

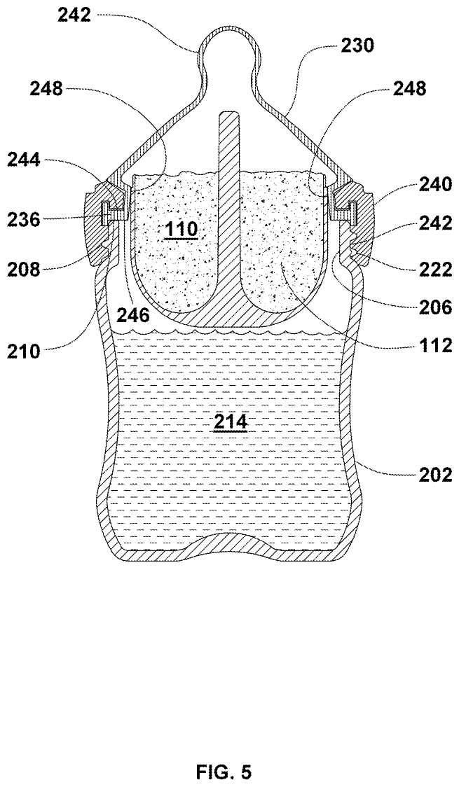

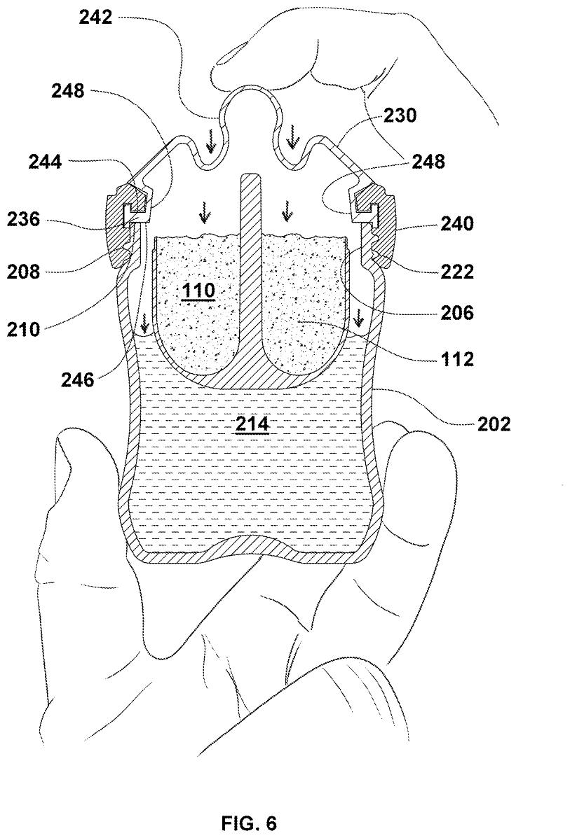

The measuring and mixing pod 100 may be filled with infant formula as described above, and inserted into the interior portion of the base 234 of the nipple 230. As will be described in greater detail with regard to FIGS. 5 and 6, the cylindrical wall 102 of the pod 100 forms a press-fit with an inner surface of the base 234 of the nipple 230. The inner surface of the base 234 of the nipple 230 frictionally engages the cylindrical wall 102 of the pod 100 to secure the pod 100 within the base 234 of the nipple 230 until the pod is purposefully released from the nipple 230 into the bottle 202. With the bottle 202 filled with water, the pod 100 filled with powdered formula, and the pod 110, the nipple 230, and the fastening ring 240 assembled, the fastening ring 240 may be rotatably secured to the neck 206 of the bottle 202. As the fastening ring 240 is rotated over the neck 206 of the bottle 202 the internal threads 242 formed on the inner surface of the fastening ring 240 engage the external threads 208 formed on the outer surface of the neck of the bottle 202 to secure the fastening ring 240, the nipple 230 and the pod 100 over the mouth 212 of the bottle 212. As the fastening ring 240 is tightened over the neck 206 of the bottle 202, the annular gasket 236 formed at the base 234 of the nipple 230 is compressed between the inward facing flange 244 of the fastening ring 240 and the annular rim 210 defined by the neck 206 of the bottle 202 to form a liquid tight seal between the bottle 202 and the nipple 230.

FIG. 5 shows a cross sectional view of a fully assembled baby bottle assembly 200 according to an embodiment of the invention. The bottle 202 is filled with water or some other fluid 214. The nipple 230 is secured over the mouth of the bottle 202 by the fastening ring 240, whose internal threads 242 engage the external threads 208 formed on the outer surface of the neck 206 of the bottle 202 to secure the fastening ring 240 to the bottle 202. The inner flange 244 of the fastening ring 240 compresses the annular gasket portion 236 of the nipple 230 between the internal flange 244 of the fastening ring 240 and the rim 210 of the bottle 202 to form a liquid-tight seal between the bottle 202 and the nipple 230. The pod 100 is filled with powdered infant formula 112 and is press-fit into the base portion 234 of the nipple 230. An internal surface 248 of the base portion 234 of the nipple 230 frictionally engages the outer surface of the cylindrical wall 102 of the pod 100 to hold the pod in place and to separate the liquid contents of the bottle 202 from the dry powdered contents of the pod 100. The notched portion 108 of the cylindrical wall 102 of the pod 100 presents a narrower outer diameter than the rest of the cylindrical wall 102. This narrower diameter surface allows the pod 100 to be frictionally retained within the base portion of a nipple having a smaller inner diameter surface than the nipple 230 shown in FIG. 5, adding greater versatility to the pod 100, as it can be employed with different baby bottle assemblies having slightly different dimensions. In the configuration shown in FIG. 5, the bottle assembly 200 may be stored and transported indefinitely with no adverse impact on the quality of the infant formula produced when the powdered contents 112 of the pod 100 are eventually mixed with the fluid contents 214 of the bottle 202.

An advantage of the configuration depicted in FIG. 5 is that the ingredients for preparing a bottle of liquid infant formula, namely fresh water and powdered infant formula, may be measured out in advance and stored and transported in a single container, yet kept separate from one another until it is time to feed the baby. This arrangement prevents the formula from spoiling as may be the case when the formula is mixed ahead of time.

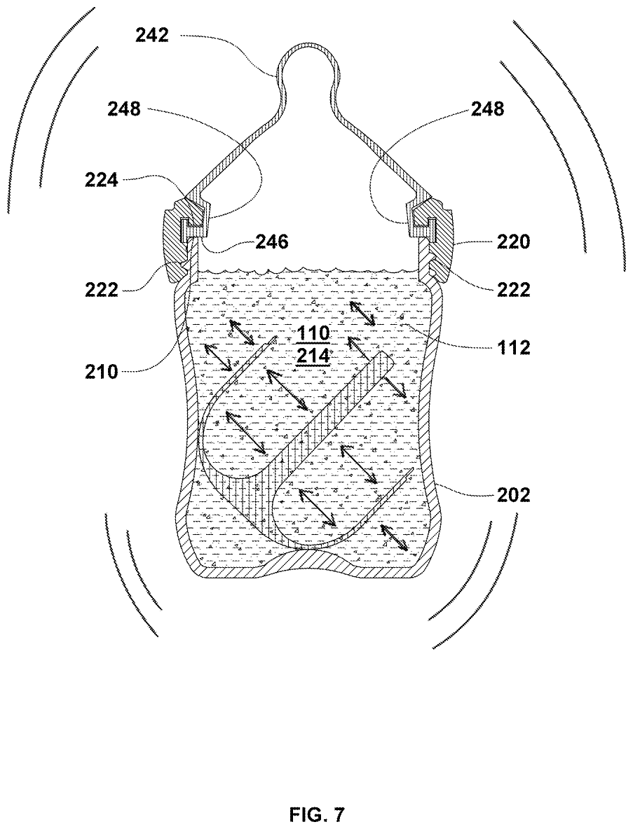

Another significant advantage of the configuration shown in FIG. 5 is the ease with which the powdered infant formula stored in the pod 100 may be mixed with the liquid contents of the bottle 202 to prepare a serving of liquid formula for feeding an infant. The mixing process may be best understood with reference to FIGS. 6 and 7. When a caregiver determines that it is time to feed the child, he or she simply grasps the bottle assembly 200 as shown in FIG. 6. The caregiver then presses down on the nursing portion 232 of the nipple 230. As the nipple 230 is made of a flexible, resilient material, the nipple 230 compresses under the pressure of the caregiver's finger, allowing the caregiver to press down on the push rod or post 106 extending upward from the pod 100. Continued pressure from the caregiver's thumb or finger overcomes the frictional forces holding the pod 100 in place within the base portion 234 of the nipple 230, forcing the pod 100 downward into the bottle 202. Eventually the pod 100 clears the nipple 230 and is released into the liquid contents 214 of the bottle 202. The pod sinks into the liquid, releasing the powdered contents of the pod 100 into the liquid 214. As the powdered contents of the pod 100 are dispersed into the liquid, the caregiver may vigorously shake the bottle to mix the powdered infant formula with the liquid contents 214 of the bottle 202. The mixing pod 100 aids in this process by acting as an agitator, breaking up clumps of dried powder and thoroughly and evenly mixing the powdered formula within the liquid contents of the bottle. The result is fresh, smooth, evenly mixed serving of infant formula ready to be ingested by a baby.

Various embodiments of the invention have been described and illustrated; however, the description and illustrations are by way of example only. Other embodiments and implementations are possible within the scope of the invention and will be apparent to those of ordinary skill in the art. Therefore, the invention is not limited to the specific details of the representative embodiments and illustrated examples in this description. Accordingly, the invention is not to be restricted except as necessitated by the accompanying claims and their equivalents.

What is claimed is:

1. A measuring and mixing pod for storing powdered infant formula within a baby bottle assembly and selectively mixing the powdered infant formula with liquid contents of the baby bottle assembly to prepare a serving of liquid infant formula adapted to be fed to a baby from the baby bottle assembly, the baby bottle assembly including a bottle having a threaded neck portion and being adapted to hold a specific volume of liquid, a flexible and resilient nipple, and a threaded fastening ring adapted to secure the nipple to the bottle, the measuring and mixing pod comprising:
a generally cylindrically shaped wall;
a base enclosing a lower end of the generally cylindrically shaped wall; and
a post extending upward from the base axially within the generally cylindrically shaped wall, the post having a height greater than a height of the generally cylindrically shaped wall;
the generally cylindrically shaped wall, the base, and the post defining a generally toroidal cavity within the measuring and mixing pod, the cavity having a volume equal to a volume of powdered infant formula required to make a serving of liquid infant formula corresponding to the specific volume of liquid the bottle is adapted to hold.

2. The measuring and mixing pod of claim 1 wherein the base includes a flat portion allowing the pod to stand upright when placed on a flat surface.

3. The measuring and mixing pod of claim 1 wherein the generally cylindrically shaped wall has a first outer diameter corresponding to an inner diameter of a base portion of a first nipple such that an upper portion of the measuring and mixing pod may be press-fit into the base portion of the first nipple and frictionally retained therein.

4. The measuring and mixing pod of claim 3 wherein, when the upper portion of the pod is press fit into the base portion of the first nipple, an outer surface of the generally cylindrically shaped wall and an inner surface of the base portion of the first nipple create a liquid tight barrier preventing liquid contained in the bottle from mixing with powdered infant formula contained in the cavity defined by the axial wall, the base, and post of the measuring and mixing pod.

5. The measuring and mixing pod of claim 3 wherein the generally cylindrically shaped wall includes a notched upper portion, the notched upper portion of the generally cylindrically shaped wall having a second outer diameter corresponding to an inner diameter of a base portion of a second nipple, such that the notched portion of the generally cylindrically shaped wall may be press fit into the base portion of the second nipple and frictionally retained therein, the inner diameter of the base portion of the second nipple being different from the inner diameter of the base portion of the second nipple.

6. A baby bottle assembly comprising:
a bottle having a threaded neck that includes an annular rim defining a bottle mouth, the bottle adapted to hold an amount of liquid corresponding a serving size of liquid infant formula;
a flexible and resilient nipple having a nursing portion and a base portion, the base defining an annular gasket and having an inner surface that defines an inner surface diameter;
a threaded fastening ring adapted to be rotatably mounted to the neck of the bottle to secure the nipple over the mouth of the bottle, the fastening ring including an internal annular flange configured to compress the gasket defined by the base portion of the nipple against the rim of the bottle;
a measuring and mixing pod having a pod base, a cylindrical wall and a post extending axially from the pod base within the cylindrical wall, the pod base, the cylindrical wall and the post defining a cavity within the pod, the cavity having a volume substantially equal to a volume of powdered infant formula required to produce a serving of liquid infant formula corresponding to a serving size the bottle is adapted to hold, the cylindrical wall having a first outer diameter corresponding to the inner surface diameter of the inner surface of the base portion of the nipple so that the pod may be press fit into the base portion of the nipple and frictionally retained therein.

7. The baby bottle assembly of claim 6 wherein, when the pod is press fit into the base portion of the nipple, an outer surface of the cylindrical wall of the pod and the inner surface of the base portion of the nipple form a liquid tight barrier preventing liquid contents of the bottle from reaching powdered infant formula stored in the cavity defined by the pod base, the cylindrical wall and the post.

8. The baby bottle assembly of claim 6 wherein the post extending axially from the pod base extends beyond the cylindrical wall such that, when the pod is press-fit into the base portion of the nipple, the post extends toward the nursing portion of the nipple.

9. The baby bottle assembly of claim 8 wherein the pod, when press-fit into the base portion of the nipple, is adapted to be released from the base portion of the nipple by a downward force applied to the post through the nursing portion of the nipple.

10. The baby bottle assembly of claim 9 wherein the pod is adapted to act as an agitator for mixing powdered infant formula stored in the cavity defined by the pod base, the cylindrical wall and the post with the liquid contents of the bottle when the pod is released from the base portion of the nipple.

11. The baby bottle assembly of claim 6 wherein the cylindrical wall of the pod includes a notched upper portion, the notched upper portion of the cylindrical wall defining a second outer diameter corresponding to an inner surface diameter of an inner surface of a base portion of a second nipple having dimensions different from the first nipple so that the pod may be press-fit into the base portion of the second nipple and frictionally retained therein.

12. A method of preparing a serving of liquid infant formula comprising the steps of:
providing a bottle having threaded neck that includes an annular rim defining a bottle mouth, the bottle adapted to hold an amount of liquid corresponding a serving size of liquid infant formula;
providing a flexible and resilient nipple having a nursing portion and a base portion, the base defining an annular gasket and having an inner surface that defines an inner surface diameter;
providing a threaded fastening ring adapted to be rotatably mounted to the neck of the bottle to secure the nipple over the mouth of the bottle, the fastening ring including an internal annular flange configured to compress the gasket defined by the base portion of the nipple against the rim of the bottle;
providing a measuring and mixing pod having a pod base, a cylindrical wall and a post extending axially from the pod base within the cylindrical wall, the pod base, the cylindrical wall and the post defining a cavity within the pod, the cavity having a volume substantially equal to a volume of powdered infant formula required to produce a serving of liquid infant formula equal to the serving size the bottle is adapted to hold, the cylindrical wall having a first outer diameter corresponding to the inner surface diameter of the inner surface of the base portion of the nipple so that the pod may be press fit into the base portion of the nipple and frictionally retained therein;
filling the bottle with an amount of liquid corresponding to a serving size of liquid infant formula;
filling the cavity defined by the pod base, the cylindrical wall and the post with powdered infant formula;
press-fitting the pod into the base portion of the nipple;
securing the nipple over the mouth of the bottle with the fastening ring;
releasing the pod from the base of the nipple into the liquid; and
shaking the bottle to mix the powdered infant formula with the liquid.
